(19) United States
(12) Patent Application Publication
(10) Pub. No.: US 2025/0182058 A1
(43) Pub. Date: Jun. 5, 2025

(54) EFFICIENT INTERACTIVE DATA SOLICITATION, PROCESSING, AND ROUTING

(71) Applicant: Conversion Interactive Agency, LLC, Brentwood, TN (US)

(72) Inventors: Patrick J. Grace, Brentwood, TN (US); Lance R. Britton, Brentwood, TN (US)

(73) Assignee: Conversion Interactive Agency, LLC, Brentwood, TN (US)

(21) Appl. No.: 18/526,842

(22) Filed: Dec. 1, 2023

(51) Int. Cl. G06Q 10/1093

(52) U.S. Cl. CPC G06Q 10/1095

(57) ABSTRACT

A method of receiving and processing first information pertaining to a request for second information includes transmitting, over a computing network, the processed first information, including the request for the second information, to at least one request dissemination system. The second information is received from a respondent and processed. A pre-qualification based on the second information is performed. Responsive to successful pre-qualification, scheduling options are transmitted to the respondent for an interview regarding the request and the second information. A call between an interviewer and the respondent is conducted based on the request and the second information received from the respondent. Responsive to the call between the interviewer and the respondent being completed, a database relating to the request for the second information with is updated with third information obtained during the completed call. Based on the third information, fourth information is transmitted to the respondent.

### TECHNICAL FIELD

The present disclosure generally relates to soliciting and collecting data, and more specifically relates to efficient interactive data solicitation, processing, and routing.

### BACKGROUND

Soliciting data may include soliciting responses to surveys, responses to scientific or medical studies, applications for job opportunities, proposals or bids for projects, applications for academic scholarships, applications for financial aid, applications for enrollment into academic programs, applications for government or private financial grants, applications for awards or public recognition, and applications for financing, loans, or credit. Traditionally, the solicitations are made via advertisements, and reception of the solicited data is via different communications media than the advertisements. If interviews are performed, scheduling the interviews are typically arranged via different communications media also, and typically involve back and forth communications to schedule the interview. These separate communications for the solicitations, responses, and interview scheduling are typically disjointed and take a significant amount of time to complete.

The description provided in the background section should not be assumed to be prior art merely because it is mentioned in or associated with the background section. The background section may include information that describes one or more aspects of the subject technology.

### SUMMARY

An exemplary method for efficient interactive data solicitation, processing, and routing includes receiving and processing first information pertaining to a request for second information, the first information being from a request originator. The method also includes transmitting, over a computing network, the processed first information, including the request for the second information, to at least one request dissemination system for dissemination of the request. The method additionally includes receiving and processing the second information from a respondent, the received second information being responsive to the disseminated request. Pre-qualification is performed based on the second information. Responsive to successful pre-qualification, scheduling options are transmitted to the respondent for an interview regarding the request and the second information received from the respondent. Responsive to receiving an immediate interview scheduling option selection from the respondent, a call with an interviewer is initiated based on the request and the second information received from the respondent. Responsive to the call with the interviewer being active, a call with the respondent is initiated based on the request and the second information received from the respondent. The call with the respondent is connected with the call with the interviewer to be a call between the interviewer and the respondent. Responsive to the call between the interviewer and the respondent being completed, a database relating to the request for the second information with third information obtained during the completed call is updated. Based on the third information, fourth information is transmitted to the respondent.

Responsive to receiving a future interview scheduling option selection from the respondent, a call between an interviewer and the respondent may be scheduled based on the request and the second information received from the respondent, and the interviewer and the respondent may be notified of the scheduled call.

Updating the database may include updating a database entry associated with the request for second information.

Updating the database may include updating a database entry associated with the request originator.

Updating the database may include updating a database entry associated with the interviewer.

Updating the database may include updating a database entry associated with the respondent.

The fourth information transmitted to the respondent may include a link to an online form requesting fifth information from the respondent.

The second information may include a telephone number of the respondent capable of receiving an SMS text message. While the fifth information has not been provided by the respondent, periodic reminders may be transmitted to the respondent, by SMS text message, to complete providing the fifth information.

Performance data pertaining to the interviewer may be computed based on analysis of call information in the database.

Performance data pertaining to the request may be computed based on analysis of call information in the database.

Performance data pertaining to the request originator may be computed based on analysis of call information in the database.

Performance data pertaining to the respondent may be computed based on analysis of call information in the database.

The request for the second information may be revised based on performance data computed by analyzing call information in the database. The revised request for the second information may be transmitted, over the computing network, to the at least one request dissemination system for dissemination of the revised request.

The second information may include a telephone number of the respondent capable of receiving an SMS text message. Transmitting the scheduling options to the respondent may be performed using an SMS text message.

Responsive to the call between the interviewer and the respondent being completed, the interviewer may be prompted to provide the third information obtained during the completed call for updating the database relating to the request for the second information.

The second information may include a telephone number of the respondent capable of receiving an SMS text message. Transmitting the fourth information to the respondent may be performed by SMS text message.

The second information may include an email address of the respondent. Transmitting the fourth information to the respondent may be performed by sending an email message.

The at least one request dissemination system may include a website on the internet.

The at least one request dissemination system may include an app executable by a mobile phone.

The second information from the respondent may be received from completion of a web form by the respondent. The web form may be linked to by the request for the second information disseminated by the at least one request dissemination system.

An exemplary non-transitory computer readable medium stores computer-readable instructions executable by a hardware computing processor to perform operations of a method for efficient interactive data solicitation, processing, and routing as described herein.

An exemplary system for efficient interactive data solicitation, processing, and routing includes at least one device including a hardware computing processor, the system being configured to perform operations of a method for efficient interactive data solicitation, processing, and routing as described herein. The system may include a non-transitory memory having stored thereon computing instructions, executable by the hardware computing processor, to perform operations of a method for efficient interactive data solicitation, processing, and routing as described herein.

An exemplary system for efficient interactive data solicitation, processing, and routing includes at least one device including a hardware circuit operable to perform a function, the system being configured to perform operations of a method for efficient interactive data solicitation, processing, and routing as described herein.

### BRIEF DESCRIPTION OF DRAWINGS

The disclosure is better understood with reference to the following drawings and description. The elements in the figures are not necessarily to scale, emphasis instead being placed upon illustrating the principles of the disclosure. Moreover, in the figures, like-referenced numerals may designate to corresponding parts throughout the different views.

FIG. 1 is a schematic diagram that illustrates an exemplary system for efficient interactive data solicitation, processing, and routing.

FIG. 2 is a schematic diagram that illustrates an exemplary system for efficient interactive data solicitation, processing, and routing.

FIG. 3 is a flow chart that illustrates an exemplary method for efficiently processing an interactive data solicitation.

FIGS. 4A and 4B are flow charts that illustrate exemplary methods for updating a respondent database record in conjunction with a respondent tracking system.

FIG. 5 depicts a block diagram of an example computer system in which examples described herein may be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below is intended as a description of various implementations and is not intended to represent the only implementations in which the subject technology may be practiced. As those skilled in the art would realize, the described implementations may be modified in various different ways, all without departing from the scope of the present disclosure. Accordingly, the drawings and description are to be regarded as illustrative in nature and not restrictive.

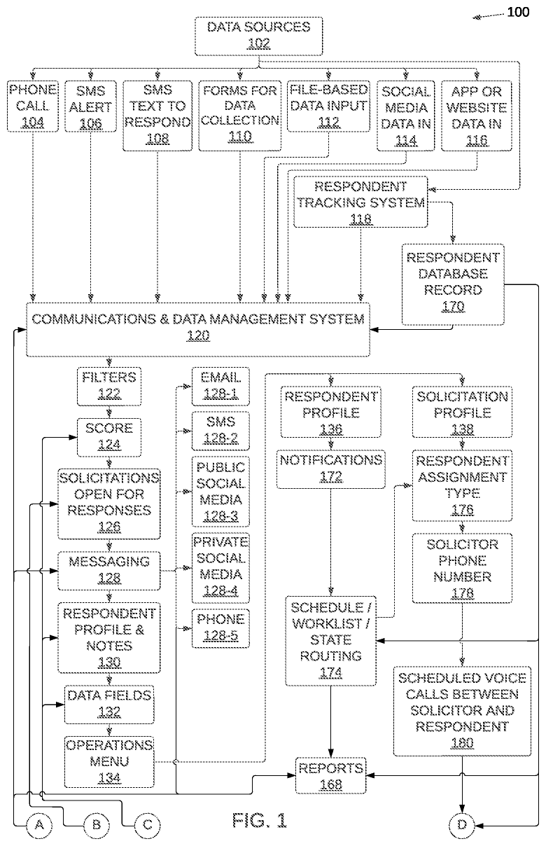

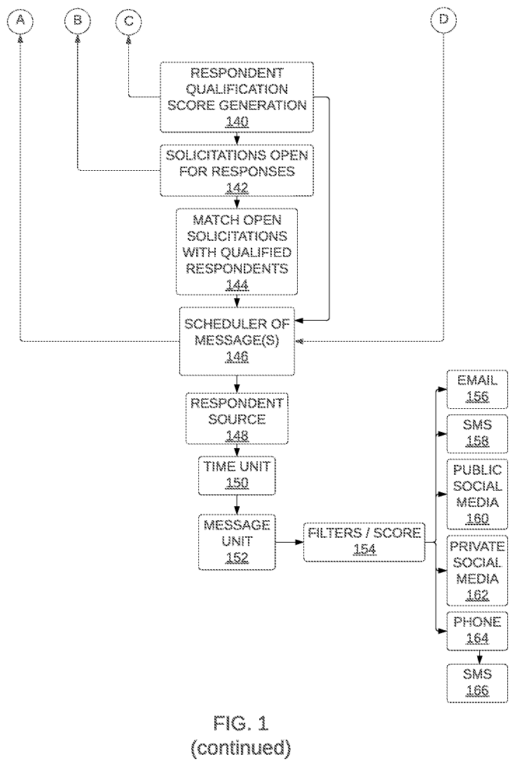

FIG. 1 is a schematic diagram that illustrates an exemplary system 100 for efficient interactive data solicitation, processing, and routing. The system 100 may solicit data to be received from multiple different data sources 102. In various examples, the solicited data may include survey responses, for example, responses to consumer surveys, responses to political surveys, responses to scientific surveys, responses to medical surveys, responses to census surveys, responses to anthropological surveys, or responses to various other types of surveys. In various examples, the solicited data may include measured values, for example, environmental conditions, scientific measurements, medical measurements, or various other values that are measured using measurement instruments. In various examples, the solicited data may include announcements or alerts about employment or job opportunities. In various examples, the solicited data may include personal data of applicants for employment, for example, in response to advertisements for employment opportunities. In various examples, the solicited data may include business data of business proposals or bids, for example, in response to business requests for proposals or bids. In various examples, the solicited data may include personal data of applicants for enrollment into academic programs. In various examples, the solicited data may include personal data of applicants for academic scholarships. In various examples, the solicited data may include personal and/or business data of applicants for government or private financial grants. In various examples, the solicited data may include personal and/or business data of applicants for financing, loans, or credit. In various examples, the solicited data may include personal and/or business data of applicants for awards or public recognition. In various examples, the solicited data may be received from the data sources 102 responsive to a solicitation for the data. In various examples, data may be received from the data sources 102 absent a solicitation and/or responsive to the system 100 querying the data sources 102 for the data.

A communications and data management system 120 may receive the data from the data sources 102 via one or more of a phone call 104, a short message service (SMS) alert 106 (e.g., a text message alert), an SMS text to respond message 108, forms for data collection 110, file-based data input 112, social media data input 114, app or website data input 116, a respondent tracking system 118, and/or a respondent database record 170 added or updated based on the data from the respondent tracking system 118. As used herein, the term “call” may include any interactive two-way communications between two end points (e.g., an interviewer's communications equipment and a respondent's communications equipment) via one or more different communications technologies, for example, voice telephone call, video call, two-way mobile radio communications, etc.

The phone call 104 may include a voice telephone call, for example, via a land-line phone using plain old telephone service (POTS) and/or a public switched telephone network (PSTN). The phone call 104 may include a voice telephone call, for example, via a voice over internet protocol (VOIP) telephone service. The phone call 104 may include a voice telephone call, for example, via a wireless mobile telephone service or cellular telephone service. If an incoming phone call 104 is missed or not answered, the incoming phone call 104 may be routed to a voice mail answering system, and a voice message may be recorded for later review and analysis. The system 100 and/or communications and data management system 120 may utilize an application programming interface (API) in conjunction with a computing processor to interact with a caller via the phone call 104 using a computationally-generated voice interface and obtain data from the caller in response to voice prompts. The system 100 and/or communications and data management system 120 may utilize an API in conjunction with the computing processor to process, categorize, and/or extract data from the voice message(s) left by the caller. The API may provide functionality for performing telephone call tracking and analyzing telephone conversations.

The SMS alert 106 and/or SMS text to respond 108 may include a text message, for example, via a cellular telephone service or a VOIP telephone service. The SMS alert 106 and/or SMS text to respond 108 may include or pertain to, at least in part, the solicited data. The system 100 and/or communications and data management system 120 may utilize an API in conjunction with a computing processor to interact with a sender of the SMS alert 106 and/or SMS text to respond 108 and obtain data from the sender via one or more text messages in response to text prompts. The system 100 and/or communications and data management system 120 may utilize an API in conjunction with the computing processor to process, categorize, and/or extract data from the text messages. The system 100 and/or communications and data management system 120 may utilize an API in conjunction with the computing processor to input data from the text messages into one or more forms, spreadsheets, tables, and/or databases.

The forms for data collection 110, social media data input 114, app or website data input 116, and/or respondent tracking system 118 may include web forms provided on a website and/or application forms provided on an application software (e.g., an “app”) interface in which website visitors and/or app users may input solicited data. The web forms and/or app forms may be accessible over the internet and/or a private data communications network, e.g., a Wi-Fi network or an Ethernet network. The web forms may be implemented using a hypertext transfer protocol (HTTP) computer communications protocol web server. The app forms may be implemented using one or more computer programming languages and/or graphical user interface (GUI) APIs. In various examples, the forms for data collection 110, social media data input 114, app or website data input 116, and/or respondent tracking system 118 may be provided electronically using one or more other electronic or computer communications technologies as known in the art. The system 100 and/or communications and data management system 120 may utilize an API in conjunction with a computing processor to process, categorize, and/or extract data from the forms for data collection 110, social media data input 114, app or website data input 116, and/or respondent tracking system 118. The system 100 and/or communications and data management system 120 may utilize an API in conjunction with the computing processor to input data from the forms for data collection 110, social media data input 114, app or website data input 116, and/or respondent tracking system 118 into one or more spreadsheets, tables, and/or databases.

The file-based data input 112 may include file upload functionality provided on a website via which website visitors may upload files providing the solicited data. The file upload functionality may be accessible over the internet and/or a private data communications network, e.g., a Wi-Fi network or an Ethernet network. The file upload functionality may be implemented using a hypertext transfer protocol (HTTP) computer communications protocol web server. In various examples, the file-based data input 112 may be provided electronically using one or more other electronic or computer communications technologies as known in the art. The system 100 and/or communications and data management system 120 may utilize an API in conjunction with a computing processor to process, categorize, and/or extract data from the file-based data input 112. The system 100 and/or communications and data management system 120 may utilize an API in conjunction with the computing processor to input data from the file-based data input 112 into one or more spreadsheets, tables, and/or databases.

In various examples, a website page, social media page, or app may provide a solicitation for data and one or more of a form for inputting the solicited data, a phone number for texting the solicited data or calling to provide the solicited data by voice in response to voice prompts, an email address to which an email message providing the solicited data may be sent, and/or a file upload option for uploading a data file providing the solicited data. The system 100 and/or communications and data management system 120 may utilize an API in conjunction with the computing processor to process, categorize, and/or extract data received in response to the solicitation for the data according to the purposes that the data was solicited.

The respondent tracking system 118 may track interactions between respondents to the solicitation for data and the system 100. The respondent tracking system 118 may add or update a respondent database record 170 according to data provided via the tracked interactions between respondents to the solicitation for data and the system 100. The tracked interactions may include communications such as email messages, SMS text messages, instant messages (IMs), etc. The respondent tracking system 118 may enforce governance rules such as those relating to opting into or opting out of electronic communications. The respondent tracking system 118 may log and maintain logs of communications and tracking data for an extended period of time as determined by the system 100, for example, one or more weeks, one or more months, one or more years, etc. The respondent tracking system 118 may provide a near-real-time data feed to the communications and data management system 120 and the respondent database record 170. The respondent database record 170 may include an API for providing the near-real-time data feed for adding and/or updating database records associated with tracked respondents. Data from the respondent database record 170 may be provided to the communications and data management system 120 and/or other modules of the system 100 as discussed herein upon request.

One or more filters 122 may receive the data from the communications and data management system 120 and filter the data according to one or more characteristics. For example, the filters 122 may remove or discard received data if the data does not have certain specified characteristics, or the filters 122 may remove or discard received data if the data does have certain prohibited characteristics. For example, if the data is specified to include responses specifying a valid commercial driver license, data that does not specify a valid commercial driver license may be filtered out. Data which is not filtered out by the filters 122 may be passed on to a score module 124 for further processing, whereas data that is filtered out may not be passed on to the score module 124.

The score module 124 may analyze data received from the filters 122 and assign score values to the analyzed data. A score may be assigned according to a score configuration of a respondent qualification score generation module 140. The respondent qualification score generation module 140 may qualify a respondent according to qualification factors of a solicitation to which the respondent is responding. The respondent qualification score generation module 140 may map responses and/or answers of the respondent to inquiries and/or questions of the solicitation. A score may be assigned to the data based on one or more factors, for example, how complete the data is according to a specified data completeness schedule, or how close values of the data are to desired data values according to a specified desired data values schedule. The scored data, including the assigned score values, may then be passed on to a solicitations open for responses module 126.

The solicitations open for responses module 126 may include a list of solicitations for data that are presently seeking responses, for example, a list of consumer surveys, a list of scientific studies, a list of open job or employment opportunities, or a list of other types of solicitations for data as discussed elsewhere herein. The solicitations open for responses module 126 may receive a list of solicitations open for responses from a solicitations open for responses module 142. The solicitations open for responses module 142 may receive and incorporate score configuration data from the respondent qualification score generation module 140. The scored data may be matched to one or more of the solicitations for data presently seeking responses, and matched data identifying the one or more matched open solicitations may be passed to a messaging module 128.

For each match of data with open solicitation received from the solicitations open for responses module 126, the messaging module 128 may facilitate communications messaging with a provider or source of the data (e.g., respondent) and/or an originator of the open solicitation with which the data had been matched. The communications messaging may include email performed via an email module 128-1, an SMS text message via an SMS module 128-2, a public social media message via a public social media module 128-3, a private social media message via a private social media module 128-4, and/or a voice phone call via a phone module 128-5.

Additional data and information pertaining to the matched data obtained via the messaging module 128 (e.g., a profile of the respondent that was the provider or source of the data, a messaging transcript, notes taken from the messaging, etc.) may be obtained, stored, and processed by a respondent profile and notes module 130. The respondent profile and notes module 130 may also receive and incorporate score configuration data from the respondent qualification score generation module 140. The additional data and information, as well as score configuration data from the respondent qualification score generation module 140, may be assigned to one or more data fields by the data fields module 132.

An operations menu 134 may provide options for utilizing the data and information, for example, in association with a respondent profile 136 and/or a solicitation profile 138. The respondent profile 136 may be associated with a provider of data in response to a solicitation, whereas the solicitation profile 138 may be associated with the solicitation for the data and/or an entity (e.g., business, nonprofit institution, etc.) responsible for the solicitation.

Various notifications 172 may be configured in association with the respondent profile 136. For example, one or more notifications 172 may be configured to notify a respondent of activity related to solicitations that the respondent is interested in or that have characteristics that match interests specified by the respondent. For example, one or more notifications 172 may be configured to notify one or more entities associated with one or more solicitations of the respondent's designated interests and/or characteristics that may match with the associated one or more solicitations.

A schedule/worklist/state routing 174 may be configured for the associated respondent based on one or more solicitations with which the respondent may be matched or interested in and/or the respondent database record 170. Future matches between the respondent and one or more solicitations may be dependent upon a respondent's availability for matching or participating with the solicitation according to the schedule/worklist/state routing 174 as established by the respondent and/or previous matches between the respondent and other solicitations.

A respondent assignment type 176 may be established based on the associated solicitation profile 138 and the associated respondent's schedule/worklist/state routing 174. A solicitor phone number 178 may be associated with the solicitation profile 138. Scheduled voice telephone calls between the solicitor and the respondent 180 may be scheduled, for example, according to the combination of the respondent profile 136 and solicitation profile 138 as discussed above. At the designated scheduled time, the system 100 may establish the scheduled voice call by calling both the respondent and the solicitor and connecting them together in a conference call bridge. In the event that a call cannot be completed with at least one of the respondent and the solicitor at the scheduled time, a scheduler of message(s) 146 may leave one or more messages with the respondent, solicitor, or both. The messages left may include a request or instructions to schedule another time for the voice call, another time for which the voice call has been rescheduled, or alternative instructions for communicating the information intended to be conveyed during the scheduled voice call. The scheduler of message(s) 146 may schedule one or more messages to be sent to the respondent and/or entities responsible for one or more solicitations according to output of a matching of open solicitations with qualified respondents module 144, score configuration data from the respondent qualification score generation module 140, and/or one or more entries of the respondent database record 170.

The one or more messages scheduled by the scheduler of message(s) 146 may be sent to and/or via a respondent source 148, e.g., the one or more data sources 102 associated with the respondent. The one or more messages scheduled may be configured according to a time unit 150, a message unit 152, and a filters/score module 154. The one or more messages may be sent via an email module 156, an SMS text module 158, a public social media module 160, a private social media module 162, and/or a phone module 166. The phone module 166 may sent the one or more messages via a voice call, a voice mail message, or via an SMS text module 166. Each of the email module 156, SMS text module 158, public social media module 160, private social media module 162, phone module 166, and/or SMS text module 166 may be integrated with an SMS text messaging service via an API.

A reports module 168 may generate reports based on one or more outputs of the messaging module 168, schedule/worklist/state routing module 174, and respondent database record 170. The reports module 168 may send generated reports out to one or more respondents and/or entities associated with one or more solicitations via the messaging module 168.

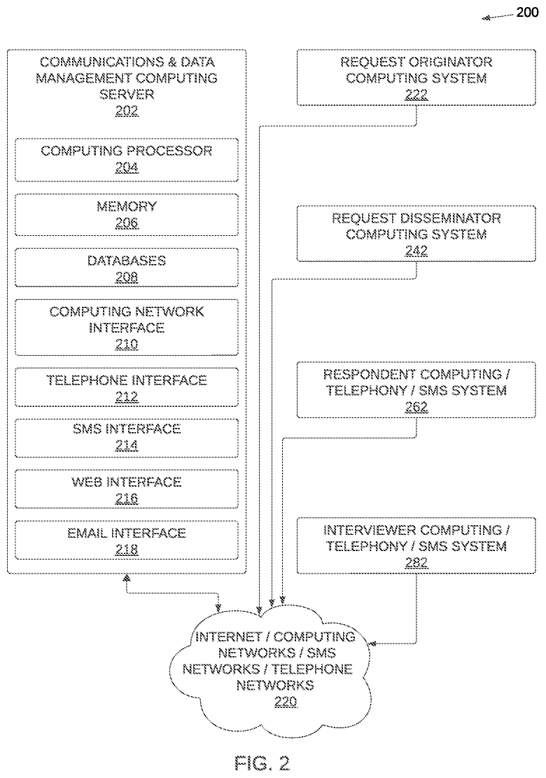

FIG. 2 is a schematic diagram that illustrates an exemplary system 200 for efficient interactive data solicitation, processing, and routing. The exemplary system 200 may include an example of the exemplary system 100. A communications and data management computing server 202 may include an example of the communications and data management system 120 and/or other components of the exemplary system 100. The communications and data management computing server 202 may include a computing processor 204, a memory 206, and one or more databases 208. The memory 206 may include one or more nontransitory memory devices, e.g., random access memory (RAM), read only memory (ROM), rewriteable disk drive data storage devices, etc. on which computer-readable computing instructions (e.g., computer software code) and data (e.g., the one or more databases 208) may be stored. The computing processor 204 may be communicatively coupled with the memory 206 and the one or more databases 208 via a data bus or other computer communications technology for transferring data.

The communications and data management computing server 202 may include a computing network interface 210 for establishing and performing computing communications between the communications and data management computing server 202 and other computer communications devices external to the communications and data management computing server 202, for example, those coupled with other computing systems, via an internet/computing networks/SMS networks/telephone networks cloud 220. The computing network interface 210 may be communicatively coupled with the internet/computing networks/SMS networks/telephone networks cloud 220 via one or more of a telephone interface 212, an SMS interface 214, a web interface 218, and an email interface 218. The telephone interface 212 may provide a communications interface with a plain old telephone service (POTS), voice over IP (VOIP), cellular telephone, or other type of voice telephone communications system. The SMS interface 214 may provide a communications interface with an SMS text messaging system. The web interface 216 may provide a communications interface with an HTTP-based world wide web server and/or communications system, for example, via a web browser application. The email interface 218 may provide a communications interface with email server systems.

A request originator computing system 222 may include one or more components similar or equivalent to those illustrated as being included in the communications and data management computing server 202. The request originator computing system 222 may originate a request or solicitation for data, for example, to be provided by respondents. The request originator computing system 222 may be associated with an entity performing a survey, performing a scientific study, performing a medical study, seeking applicants for jobs, seeking bids or proposals in response to solicitations for bids or proposals, etc.

A request disseminator computing system 242 may include one or more components similar or equivalent to those illustrated as being included in the communications and data management computing server 202. The request disseminator computing system 242 may disseminate a request or solicitation for data, for example, originated by the request originator computing system 222, to one or more other computing systems to facilitate dissemination to potential respondents who may provide the requested data. The request disseminator computing system 242 may be associated with an entity that aggregates and/or advertises opportunities for participating in surveys or studies, employment opportunities, solicitations for bids or proposals, etc.

A respondent computing/telephony/SMS system 262 may include one or more components similar or equivalent to those illustrated as being included in the communications and data management computing server 202. The respondent computing/telephony/SMS system 262 may be associated with a respondent to a request or solicitation for data, for example, originated by the request originator computing system 222. The respondent may provide the requested data to the communications and data management computing server 202, the request disseminator computing system 242, and/or the request originator computing system 222 via the respondent computing/telephony/SMS system 262. The respondent computing/telephony/SMS system 262 may be contacted by the communications and data management computing server 202 to schedule a time and communications medium for performing an interview with an interviewer, who may. query the respondent and obtain data from the respondent in response to the request originated by the request originator.

An interviewer computing/telephony/SMS system 282 may include one or more components similar or equivalent to those illustrated as being included in the communications and data management computing server 202. The interviewer computing/telephony/SMS system 282 may be associated with an interviewer who may interview a respondent to a request or solicitation for data, for example, originated by the request originator computing system 222. The respondent may provide the requested data during and/or in association with the interview by the interviewer. The interviewer computing/telephony/SMS system 282 may be contacted by the communications and data management computing server 202 to schedule a time and communications medium for performing the interview with the respondent. The interviewer computing/telephony/SMS system 282 may provide data obtained from the respondent, during or in association with the interview, to the communications and data management computing server 202 and/or the request originator computing system 222.

The communications and interactions between and among the request originator computing

system 222, the request disseminator computing system 242, the respondent computing/telephony/SMS system 262, and the interviewer computing/telephony/SMS system 282 via the internet/computing networks/SMS networks/telephone networks cloud 220, may be coordinated and/or controlled by the communications and data management computing server 202.

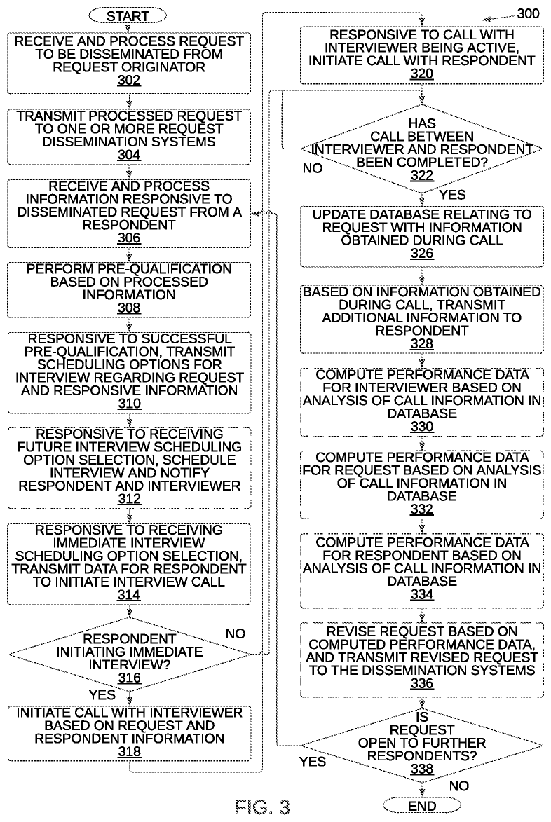

FIG. 3 is a flow chart that illustrates an exemplary method 300 for efficiently processing an interactive data solicitation. The method 300 may be performed using one or more examples of the system 100 and/or the system 200.

In an operation 302, a request to be disseminated from a request originator may be received and processed. In an example, the request may be originated by the request originator computing system 222 and received by the communications and data management computing server 202.

In an operation 304, the request processed in operation 302 may be transmitted to one or more request dissemination systems, e.g., for dissemination to potential respondents. In an example, the communications and data management computing server 202 may transmit the request to one or more request disseminator computing systems 242. In an example, the communications and data management computing server 202 may cause the one or more request disseminator computing systems 242 to disseminate the request.

In an operation 306, information responsive to the disseminated request may be received from a respondent and processed. In an example, the responsive information may be received and processed by the communications and data management computing server 202. In an example, the responsive information may be received and processed by the system 100. In an example, the responsive information may be received from the respondent computing/telephony/SMS system 262.

In an operation 308, a pre-qualification is performed based on the information processed in operation 306. In an example, the pre-qualification may be performed by the communications and data management computing server 202. In an example, the pre-qualification may be performed by the system 100. In an example, the pre-qualification may be performed on the respondent, e.g., via the respondent computing/telephony/SMS system 262.

In an operation 310, responsive to a successful pre-qualification in operation 308, one or more scheduling options for an interview regarding the request and responsive information may transmitted. The one or more scheduling options may be transmitted to the respondent computing/telephony/SMS system 262 and/or the interviewer computing/telephony/SMS system 282. In an example, the one or more scheduling options may be transmitted by the communications and data management computing server 202. In an example, the one or more scheduling options may be transmitted by the system 100.

In an optional operation 312, responsive to receiving a future interview scheduling option selection, an interview may be scheduled and the respondent and interviewer may be notified. In various examples, the future interview scheduling option selection may be received by the communications and data management computing server 202. In various examples, the future interview scheduling option selection may be received by the system 100. In various examples, the future interview scheduling option selection may be received from one or both of the respondent computing/telephony/SMS system 262 and the interviewer computing/telephony/SMS system 282. In various examples, when one or more future interview scheduling option selections are received from both of the respondent computing/telephony/SMS system 262 and the interviewer computing/telephony/SMS system 282, the received future interview scheduling option selections may be matched to each other to identify one or more future interview scheduling option selections that are provided at the same time and/or using the same communications medium from both of the respondent computing/telephony/SMS system 262 and the interviewer computing/telephony/SMS system 282. In various examples, the notification to the respondent and interviewer may include a calendar appointment invitation. In various examples, the calendar appointment invitation may specify a scheduled time and/or a scheduled communications medium.

In an operation 314, responsive to receiving an immediate interview scheduling option selection, data may be transmitted to the respondent computing/telephony/SMS system 262 for the respondent to initiate the interview. In various examples, the immediate interview scheduling option selection may be received by the communications and data management computing server 202. In various examples, the immediate interview scheduling option selection may be received by the system 100. In various examples, the immediate interview scheduling option selection may be received from one or both of the respondent computing/telephony/SMS system 262 and the interviewer computing/telephony/SMS system 282. In various examples, when the immediate interview scheduling option selections are received from both of the respondent computing/telephony/SMS system 262 and the interviewer computing/telephony/SMS system 282, the data for the respondent to initiate the interview call may be transmitted. In various examples, both the respondent computing/telephony/SMS system 262 and the interviewer computing/telephony/SMS system 282 may be notified that the respondent is to immediately initiate the interview.

In an operation 316, a determination may be made regarding whether the respondent, e.g., via the respondent computing/telephony/SMS system 262, is initiating an immediate interview. In various examples, the determination may be made by the communications and data management computing server 202. In various examples, the determination may be made by the system 100. If the determination is yes, e.g., the respondent is initiating an immediate interview, an interview call with the interviewer may be initiated in an operation 318 based on the request and the respondent information. In various examples, the interview call may be initiated by the communications and data management computing server 202. In various examples, the interview call may be initiated by the system 100. In various examples, the interview call may be initiated with the interviewer computing/telephony/SMS system 282 using a call bridge of the communications and data management computing server 202 or the system 100, or using a communications medium as specified in association with one or more received immediate interview scheduling option selections.

In an operation 320, responsive to the call with the interviewer being active, an interview call with the respondent may be initiated, for example, based on the request and the respondent information. In various examples, the interview call may be initiated by the communications and data management computing server 202. In various examples, the interview call may be initiated by the system 100. In various examples, the interview call may be initiated with the respondent computing/telephony/SMS system 262 using a call bridge of the communications and data management computing server 202 or the system 100, or using a communications medium as specified in association with one or more received immediate interview scheduling option selections. Once the interview call has been initiated with both the respondent computing/telephony/SMS system 262 and the interviewer computing/telephony/SMS system 282, the interview calls with each of the respondent computing/telephony/SMS system 262 and the interviewer computing/telephony/SMS system 282 may be bridged together to facilitate two-way communications directly between the interviewer and the respondent. The two-way communications between the interviewer and the respondent may be hosted and/or controlled by the communications and data management computing server 202 or the system 100 and conducted via the respondent computing/telephony/SMS system 262 and the interviewer computing/telephony/SMS system 282.

After operation 320 is completed, or if the determination in operation 316 is no, e.g., the respondent is not initiating an immediate interview, then the method may continue to operation 322 for determining whether a call between the interviewer and the respondent has been completed. The method may not proceed beyond operation 322 until the call between the respondent computing/telephony/SMS system 262 and the interviewer computing/telephony/SMS system 282 has been completed.

In an operation 326, after the call between the respondent computing/telephony/SMS system 262 and the interviewer computing/telephony/SMS system 282 has been completed, a database relating to the request may be updated with information obtained during the call. In various examples, the communications and data management computing server 202 or the system 100 may update the database relating to the request. In various examples, the interviewer computing/telephony/SMS system 282 may transmit the information obtained during the call to the communications and data management computing server 202 or the system 100 to update the database relating to the request.

In an operation 328, based on information obtained during the call, additional information may be transmitted to the respondent computing/telephony/SMS system 262. In various examples, the additional information may be transmitted by the communications and data management computing server 202 or the system 100. In various examples, the obtained information upon which the additional information to be transmitted may be transmitted by the interviewer computing/telephony/SMS system 282 to the communications and data management computing server 202 or the system 100. In various examples, the interviewer computing/telephony/SMS system 282 may control the communications and data management computing server 202 or the system 100 to transmit the additional information to the respondent computing/telephony/SMS system 262. In various examples, the additional information may include requests for additional information, e.g., demographic information of the respondent, and/or additional questions for obtaining additional data associated with the survey, study, bid, proposal, application, etc. that was the subject of the interview. In various examples, the additional information may include a summary or results of the interview. In various examples, the additional information may include an indication of whether the respondent will receive an acceptance of a bid, an award or offer in response to the respondent's application or proposal, etc.

In an optional operation 330, performance data for the interviewer associated with the interviewer computing/telephony/SMS system 282 may be computed based on analysis of call information in a database, e.g., the database relating to the request, the database relating to the respondent, the database relating to the interviewer, or another database relating to the call. In various examples, the performance data may be computed by the communications and data management computing server 202 or the system 100.

In an optional operation 332, performance data for the request associated with the request originator computing/telephony/SMS system 222 may be computed based on analysis of call information in a database, e.g., the database relating to the request, the database relating to the respondent, the database relating to the interviewer, or another database relating to the call. In various examples, the performance data may be computed by the communications and data management computing server 202 or the system 100.

In an optional operation 334, performance data for the respondent associated with the respondent computing/telephony/SMS system 262 may be computed based on analysis of call information in a database, e.g., the database relating to the request, the database relating to the respondent, the database relating to the interviewer, or another database relating to the call. In various examples, the performance data may be computed by the communications and data management computing server 202 or the system 100.

In an optional operation 336, the request associated with the request originator computing/telephony/SMS system 222 may be revised based on the computed performance data, and the revised request may be transmitted to one or more request disseminator computing systems 242. In various examples, the request may be revised by the communications and data management computing server 202, the system 100, the request originator computing/telephony/SMS system 222, or a combination in coordination with one another. For example, the request originator computing/telephony/SMS system 222 may revise the request responsive to information or instructions for revising the request transmitted to the request originator computing/telephony/SMS system 222 by the communications and data management computing server 202 or the system 100. In various examples, the request originator computing/telephony/SMS system 222, the communications and data management computing server 202, or the system 100 may transmit the revised request to the one or more request disseminator computing systems 242.

In an operation 338, a determination may be made regarding whether the request is open to further respondents. In the event that the determination is made that the request is open to further respondents, the method 300 may return to operation 306 to receive and process information responsive to the request from one or more other respondents. In the event that the determination is made that the request is not open to further respondents, the method 300 may end.

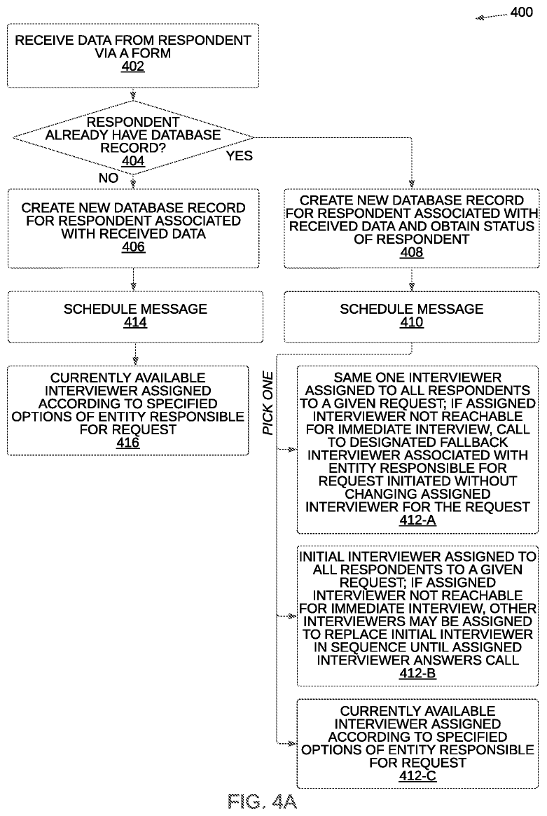

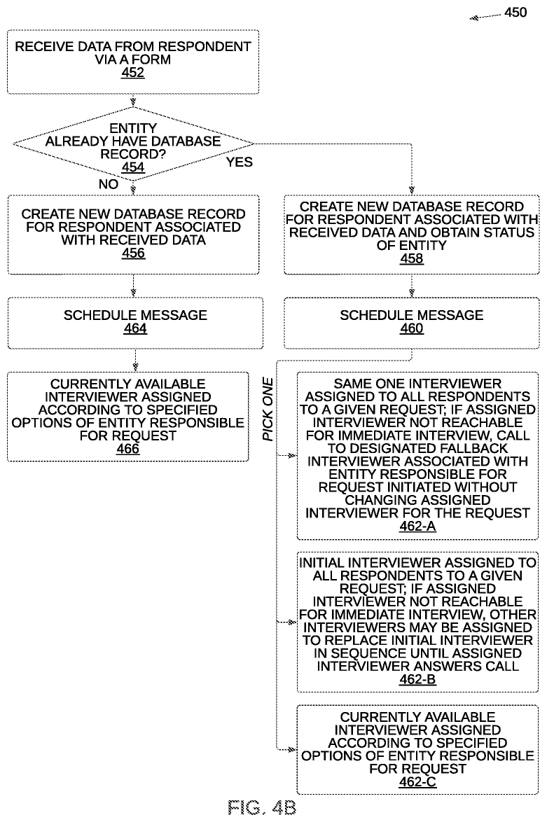

FIG. 4A is a flow chart that illustrates an exemplary method 400 for updating a respondent database record in conjunction with a respondent tracking system. In various examples, the method 400 may be performed by the system 100 in conjunction with the respondent tracking system 118 to add or update the respondent database record 170. The method 400 may be performed in conjunction with operations of the method 300.

In an operation 402, data responsive to a request is received from a respondent via a form. The form may include an example of the forms for data collection 110.

In an operation 404, a determination may be made regarding whether the respondent has a record in the database already. The record in the database may be an example of the respondent database record 170. If the determination is made that the respondent does not already have a record in the database, then in operation 406, a new database record for the respondent associated with the data received in operation 402 is created. In various examples, the new database record may be an example of the respondent database record 170, and the new database record may be created by the system 100. If the determination is made that the respondent already has a record in the database, then in operation 408, a new database record for the respondent associated with the data received in operation 402 is created and a status of the respondent is obtained. In various examples, the status of the respondent may be obtained from the respondent database record 170 by the system 100.

In an operation 410, a message is scheduled. The message may be scheduled by the scheduler of message(s) to the respondent 146. In an operation 412, after the message is scheduled, one of three options for assigning an interviewer to the respondent may be employed. In a first option 412-A, a same one interviewer may be assigned to all respondents to a given request, and if the assigned interviewer is not reachable for an immediate interview in operation 318, a call to a designated fallback interviewer associated with the entity responsible for the request and/or the request originator computing system 222 may be initiated in operation 318 while not changing the assigned interviewer for the request in a database entry associated with the request. In a second option 412-B, an initial interviewer may be assigned to all respondents for a given request, and if the assigned interviewer is not reachable for an immediate interview in operation 318, other interviewers may be assigned to replace the initial interviewer in a sequence until a call to a newly assigned interviewer is answered when initiated in operation 318. The assigned interviewer for the request may be changed to the newly assigned interviewer in a database entry associated with the request. In a third option 412-C, a currently available interviewer may be assigned to be called in operation 318 according to options specified in a database entry associated with the entity responsible for the request and/or the request originator computing system 222.

In an operation 414, a message is scheduled. The message may be scheduled by the scheduler of message(s) to the respondent 146. In an operation 416, a currently available interviewer may be assigned to be called in operation 318 according to options specified in a database entry associated with the entity responsible for the request and/or the request originator computing system 222.

FIG. 4B is a flow chart that illustrates an exemplary method 450 for updating a respondent database record in conjunction with a respondent tracking system. In various examples, the method 450 may be performed by the system 100 in conjunction with the respondent tracking system 118 to add or update the respondent database record 170. The method 450 may be performed in conjunction with operations of the method 300.

In an operation 452, data responsive to a request is received from a respondent via a form. The form may include an example of the forms for data collection 110.

In an operation 454, a determination may be made regarding whether the entity responsible for the request and/or the request originator computing system 222 has a record in a database already. If the determination is made that the entity responsible for the request and/or the request originator computing system 222 does not already have a record in the database, then in operation 456, a new database record for the respondent associated with the data received in operation 452 is created. In various examples, the new database record may be an example of the respondent database record 170, and the new database record may be created by the system 100. If the determination is made that the entity responsible for the request and/or the request originator computing system 222 already has a record in the database, then in operation 458, a new database record for the respondent associated with the data received in operation 402 is created and a status of the entity responsible for the request and/or the request originator computing system 222 is obtained. In various examples, the status of the entity responsible for the request and/or the request originator computing system 222 may be obtained from the associated database record by the system 100.

In an operation 460, a message is scheduled. The message may be scheduled by the scheduler of message(s) to the respondent 146. In an operation 462, after the message is scheduled, one of three options for assigning an interviewer to the respondent may be employed. In a first option 412-A, a same one interviewer may be assigned to all respondents for a given request, and if the assigned interviewer is not reachable for an immediate interview in operation 318, a call to a designated fallback interviewer associated with the entity responsible for the request and/or the request originator computing system 222 may be initiated in operation 318 while not changing the assigned interviewer for the request in a database entry associated with the entity responsible for the request and/or the request originator computing system 222. In a second option 412-B, an initial interviewer may be assigned to all respondents for a given request, and if the assigned interviewer is not reachable for an immediate interview in operation 318, other interviewers may be assigned to replace the initial interviewer in a sequence until a call to a newly assigned interviewer is answered when initiated in operation 318. The assigned interviewer for the request may be changed to the newly assigned interviewer in a database entry associated with the request. In a third option 412-C, a currently available interviewer may be assigned to be called in operation 318 according to options specified in a database entry associated with the entity responsible for the request and/or the request originator computing system 222.

In an operation 464, a currently available interviewer may be assigned to be called in operation 318 according to options specified in a database entry associated with the entity responsible for the request and/or the request originator computing system 222.

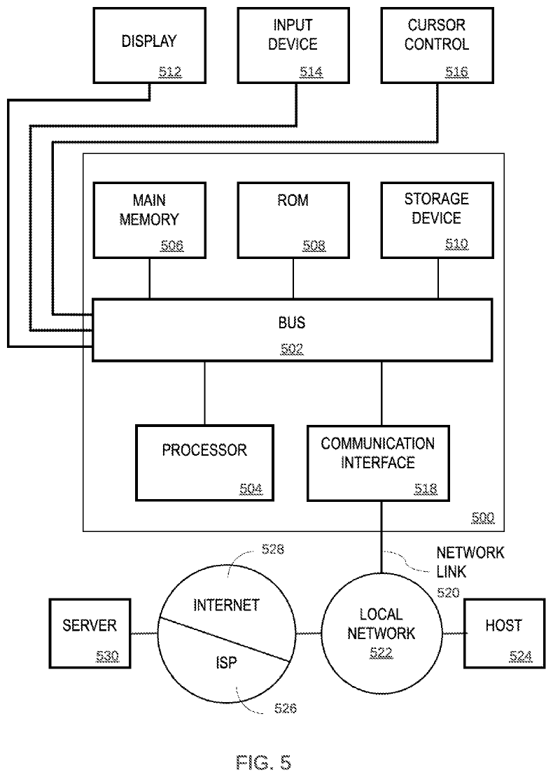

FIG. 5 depicts a block diagram of an example computer system 500 in which examples described herein may be implemented. The computer system 500 may include a bus 502 or other electronic communication mechanism for communicating information, and one or more hardware processors 504 coupled with the bus 502 for processing information. The hardware processor(s) 504 may include, for example, one or more general purpose microprocessors and/or application specific integrated circuits (ASICs) configured to perform the processes and methods described herein and related processes and methods.

The computer system 500 also may include a main memory 506, for example, a random access memory (RAM), cache, and/or other dynamic storage devices, coupled to the bus 502 for storing information and instructions to be executed by the processor(s) 504. The main memory 506 also may be used for storing temporary variables or other intermediate information during execution of instructions to be executed by the processor(s) 504. Such instructions, when stored in storage media accessible to the processor(s) 504, may render computer system 500 into a special-purpose machine that is customized to perform the operations specified in the instructions.

The computer system 500 may further include a read only memory (ROM) 508 and/or other static storage device coupled to the bus 502 for storing static information and instructions for the processor(s) 504. A storage device 510, for example, a magnetic disk, optical disk, and/or USB thumb drive (Flash drive), etc., may be provided and coupled to the bus 502 for storing information and instructions.

The computer system 500 may be coupled via the bus 502 to a display 512, for example, a liquid crystal display (LCD), light emitting diode (LED) display, touch screen, and/or other electronic display for displaying information to a computer user. One or more input device(s) 514, including alphanumeric and/or other keys, may be coupled to the bus 502 for communicating information and command selections to the processor(s) 504. Another type of user input device may include cursor control 516, for example, a mouse, a trackball, a touchpad, and/or a set of cursor direction keys for communicating direction information and command selections to the processor(s) 504 and for controlling cursor movement on the display 512. In some examples, direction information and command selections as may be provided by cursor control may also or alternatively be implemented via receiving touches on a touch screen without the use of a separate cursor control device.

The computing system 500 may include a user interface module to implement a graphical user interface (GUI) that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the words “component,” “engine,” “system,” “database,” “data store,” and the like, as used herein, may refer to logic embodied in hardware or firmware, or to a collection of software instructions, possibly having entry and exit points, written in a programming language, such as, for example, Java, C, or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression, and/or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 may cause the processor(s) 504 to perform the process steps and/or operations described herein. In alternative embodiments, hard-wired circuitry may be used in place of or in combination with software instructions.

The term “non-transitory media,” and similar terms, as used herein refers to any non-transitory media that store data and/or instructions that cause a machine to operate in a specific fashion. Such non-transitory media may comprise non-volatile media and/or volatile media. Non-volatile media includes, for example, optical or magnetic disks, such as storage device 510.

Volatile media includes dynamic memory, such as main memory 506. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 502. Transmission media may also take the form of acoustic or light waves, such as those generated during radio-wave and infra-red data communications.

The computer system 500 may also include one or more communication network interface(s) 518 coupled to the bus 502. The network interface(s) 518 may provide two-way data communication coupling to one or more network links that are connected to one or more local networks. For example, the network interface(s) 518 may include an integrated services digital network (ISDN) card, cable modem, satellite modem, or a modem to provide a data communication connection to a corresponding type of telephone line. As another example, the network interface(s) 518 may include a local area network (LAN) card to provide a data communication connection to a compatible LAN (and/or a wide area network (WAN) component to communicate with a WAN). Wireless links may also be implemented. In any such implementation, the network interface(s) 518 send and receive electrical, electromagnetic, and/or optical signals that carry digital data streams representing various types of information.

A network link typically provides data communication through one or more networks to other data devices. For example, a network link may provide a connection through a local network to a host computer or to data equipment operated by an Internet Service Provider (ISP). The ISP in turn may provide data communication services through the worldwide packet data communication network now commonly referred to as the “Internet.” Local network and Internet both use electrical, electromagnetic, and/or optical signals that carry digital data streams. The signals through the various networks and the signals on network link and through network interface(s) 518, which may carry the digital data to and from the computer system 500, are example forms of transmission media.

The computer system 500 may send messages and receive data, including program code, through the network(s), network link and network interface(s) 518. In the Internet example, a server might transmit a requested code for an application program through the Internet, the ISP, the local network, and the network interface(s) 518.

The received code may be executed by the processor(s) 504 as it is received, and/or stored in the storage 510, or other non-volatile storage for later execution.

In one aspect, a method may be an operation, an instruction, or a function and vice versa. In one aspect, a clause or a claim may be amended to include some or all of the words (e.g., instructions, operations, functions, or components) recited in other one or more clauses, one or more words, one or more sentences, one or more phrases, one or more paragraphs, and/or one or more claims.

To illustrate the interchangeability of hardware and software, items such as the various illustrative blocks, modules, components, methods, operations, instructions, and algorithms have been described generally in terms of their functionality. Whether such functionality is implemented as hardware, software or a combination of hardware and software depends upon the particular application and design constraints imposed on the overall system. Skilled artisans may implement the described functionality in varying ways for each particular application.

The functions, acts or tasks illustrated in the Figures or described may be executed in a digital and/or analog domain and in response to one or more sets of logic or instructions stored in or on non-transitory computer readable medium or media or memory. The functions, acts or tasks are independent of the particular type of instructions set, storage media, processor or processing strategy and may be performed by software, hardware, integrated circuits, firmware, microcode and the like, operating alone or in combination. The memory may comprise a single device or multiple devices that may be disposed on one or more dedicated memory devices or disposed on a processor or other similar device. When functions, steps, etc. are said to be “responsive to” or occur “in response to” another function or step, etc., the functions or steps necessarily occur as a result of another function or step, etc. It is not sufficient that a function or act merely follow or occur subsequent to another. The term “substantially” or “about” encompasses a range that is largely (anywhere a range within or a discrete number within a range of ninety-five percent and one-hundred and five percent), but not necessarily wholly, that which is specified. It encompasses all but an insignificant amount.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112 (f), unless the element is expressly recited using the phrase “means for” or, in the case of a method claim, the element is recited using the phrase “step for.”

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed, to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A computer-implemented method comprising:
receiving and processing first information pertaining to a request for second information, the first information being from a request originator;
transmitting, over a computing network, the processed first information, including the request for the second information, to at least one request dissemination system for dissemination of the request;
receiving and processing the second information from a respondent, the received second information being responsive to the disseminated request;
performing pre-qualification based on the second information;
responsive to successful pre-qualification, transmit scheduling options to the respondent for an interview regarding the request and the second information received from the respondent;
responsive to receiving an immediate interview scheduling option selection from the respondent, initiating a call with an interviewer based on the request and the second information received from the respondent;
responsive to the call with the interviewer being active, initiating a call with the respondent based on the request and the second information received from the respondent, the call with the respondent being connected with the call with the interviewer to be a call between the interviewer and the respondent;
responsive to the call between the interviewer and the respondent being completed, updating a database relating to the request for the second information with third information obtained during the completed call; and
based on the third information, transmitting fourth information to the respondent.

2. The method of claim 1, further comprising responsive to receiving a future interview scheduling option selection from the respondent:
scheduling a call between an interviewer and the respondent based on the request and the second information received from the respondent; and
notifying the interviewer and the respondent of the scheduled call.

3. The method of claim 1, wherein updating the database comprises updating a database entry associated with the request for second information.

4. The method of claim 1, wherein updating the database comprises updating a database entry associated with the request originator.

5. The method of claim 1, wherein updating the database comprises updating a database entry associated with the interviewer.

6. The method of claim 1, wherein updating the database comprises updating a database entry associated with the respondent.

7. The method of claim 1, wherein the fourth information transmitted to the respondent comprises a link to an online form requesting fifth information from the respondent.

8. The method of claim 7, wherein:
the second information comprises a telephone number of the respondent capable of receiving an SMS text message, and
while the fifth information has not been provided by the respondent, transmitting periodic reminders to the respondent, by SMS text message, to complete providing the fifth information.

9. The method of claim 1, further comprising computing performance data pertaining to the interviewer based on analysis of call information in the database.

10. The method of claim 1, further comprising computing performance data pertaining to the request based on analysis of call information in the database.

11. The method of claim 1, further comprising computing performance data pertaining to the request originator based on analysis of call information in the database.

12. The method of claim 1, further comprising computing performance data pertaining to the respondent based on analysis of call information in the database.

13. The method of claim 1, further comprising:
revising the request for the second information based on performance data computed by analyzing call information in the database; and
transmitting, over the computing network, the revised request for the second information to the at least one request dissemination system for dissemination of the revised request.

14. The method of claim 1, wherein:
the second information comprises a telephone number of the respondent capable of receiving an SMS text message, and
transmitting the scheduling options to the respondent is performed using an SMS text message.

15. The method of claim 1, further comprising:
responsive to the call between the interviewer and the respondent being completed, prompting the interviewer to provide the third information obtained during the completed call for updating the database relating to the request for the second information.

16. The method of claim 1, wherein:
the second information comprises a telephone number of the respondent capable of receiving an SMS text message, and
transmitting the fourth information to the respondent is by SMS text message.

17. The method of claim 1, wherein:
the second information comprises an email address of the respondent, and
transmitting the fourth information to the respondent is by an email message.

18. The method of claim 1, wherein the at least one request dissemination system comprises a website on the internet.

19. The method of claim 1, wherein the at least one request dissemination system comprises an app executable by a mobile phone.

20. The method of claim 1, wherein the second information from the respondent is received from completion of a web form by the respondent, the web form being linked to by the request for the second information disseminated by the at least one request dissemination system.
